(19) United States
(12) Patent Application Publication
(10) Pub. No.: US 2014/0019082 A1
(43) Pub. Date: Jan. 16, 2014

(54) METHOD OF CALCULATING STEP LENGTH

(71) Applicant: NATIONAL CHENG KUNG UNIVERSITY, Tainan (TW)

(72) Inventors: Kun-Chan LAN, Tainan (TW); Wen-Yuah SHIH, New Taipei (TW)

(21) Appl. No.: 13/935,699

(22) Filed: Jul. 5, 2013

(30) Foreign Application Priority Data
Jul. 11, 2012 (TW) 101124973

(51) Int. Cl. G01C 21/20

(52) U.S. Cl. CPC G01C 21/206
USPC 702/141

(57) ABSTRACT

A method of calculating a step length of a user, which comprises the steps: input a leg length of the user; obtain a vertical acceleration when the user is walking, wherein the vertical acceleration is sensed by an accelerometer and then removed the effect of gravity; do double integral on the vertical acceleration to obtain a vertical displacement for one step of the user; calculate a step length according to the vertical displacement and the leg length by applying Pythagorean theorem.

The current application claims a foreign priority to the patent application of Taiwan No. 101124973 filed on Jul. 11, 2012.

### BACKGROUND OF THE INVENTION

1. Technical Field

The present invention relates to an indoor positioning system, and more particularly to a method of calculating a step length.

2. Description of Related Art

GPS (Global Positioning System) is widely used in navigation of vehicle, and in present days, some mobile devices, such as smart phone, are equipped with GPS for positioning and navigation of people. However, GPS only works outdoors because the satellite signals can't get through the buildings. Therefore, if a person walks in a spacious room, such as an exhibition hall or a museum, GPS is insufficient to navigate him/her. Some techniques such as A-GPS provide indoor positioning functions; however, those techniques can only provide rough positioning. Until now, there still is no positioning system has the ability to perform accurate indoor navigation.

### BRIEF SUMMARY OF THE INVENTION

In view of the above, the primary objective of the present invention is to provide a method of calculating a step length while walking, which could be used for accurate navigation.

The present invention provides a method of calculating a step length, which comprises the steps of: A. Input a leg length of a user; B. Obtain a vertical acceleration when the user is walking; C. Do double integral on the vertical acceleration to obtain a vertical displacement for one step of the user; D. Calculate a step length according to the vertical displacement and the leg length.

In an embodiment, the leg length is a distance between a hip joint and a sole of a foot of the user.

In an embodiment, the step B comprises the steps of obtaining a static acceleration by an accelerometer when the user is standing still; obtaining a moving acceleration by the accelerometer when the user is walking; and then removing the static acceleration from the moving acceleration to obtain the vertical acceleration.

In an embodiment, an equation of calculating the vertical acceleration is An=(R−M)×sec(cos⁻¹(M/9.8)), where An is the vertical acceleration, R is the moving acceleration, and M is the static acceleration.

In an embodiment, the method further comprising the step of low-pass filtering after the step B, to filter out low frequency waves of the vertical acceleration generated by vibration.

In an embodiment, the step C comprises the steps of doing integral on the vertical acceleration to obtain a vertical velocity; and then doing another integral on an absolute value of the vertical velocity; and then a result of the second integral is divided by two to obtain the vertical displacement.

In an embodiment, the vertical acceleration is obtained via an accelerometer, and the vertical velocity is reset to zero when the accelerometer is at a highest position and a lowest position.

In an embodiment, a movement of the accelerometer is simulated as Simple Harmonic Motion (SHM).

In an embodiment, the step C comprises the steps of doing integral on the vertical acceleration to obtain a vertical velocity, and then doing another integral on an absolute value of the vertical velocity to obtain the vertical displacement for the step when the user starts to walk or stops walking.

In an embodiment, the vertical acceleration is obtained via an accelerometer, and the vertical velocity is reset to zero when the accelerometer is at a lowest position.

In an embodiment, an equation of calculating the step length in the step D is D=2×\sqrt{L²−(L−h)²}, where D is the step length, L is the leg length, and h is the vertical displacement.

In an embodiment, the method further comprises a turning angle by using a gyroscope to calculate a coordinate of the user in a 2D space, wherein the step length is combined with the turning angle to obtain a trajectory of the user in the 2D space.

In an embodiment, a X coordinate of the coordinate is obtained via an equation ^{X}^{ₙ}^{=X}^{ₙ₋₁}^{+D×cosθ}, and a Y coordinate of the coordinate is obtained via an equation ^{Y}^{ₙ}^{=Y}^{ₙ₋₁}^{+D×sinθ}, where Xₙ is the current X coordinate, Xₙ₋₁ is the previous X coordinate, Yₙ is the current Y coordinate, Yₙ₋₁ is the previous Y coordinate; and θ is the turning angle, wherein Xₙ₋₁ and Yₙ₋₁ are zero if this is the first step.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a flowchart of a preferred embodiment of the present invention;

FIG. 2 is a diagram of the relation between the vertical acceleration and time;

FIG. 3 is a sketch diagram, showing a user standing and walking;

FIG. 4 is a sketch diagram, showing the stride taken by the user.

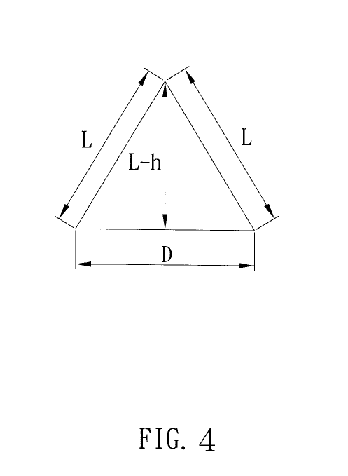

### DETAILED DESCRIPTION OF THE INVENTION

A method of calculating a step length of the preferred embodiment of the present invention is performed via a computing device, which has an accelerometer and a gyroscope. In the present embodiment, the computing device is a pedestrian dead reckoning (PDR) device to be carried by a user (hang on a belt, for example), for sensing vertical vibration and acceleration when the user walks.

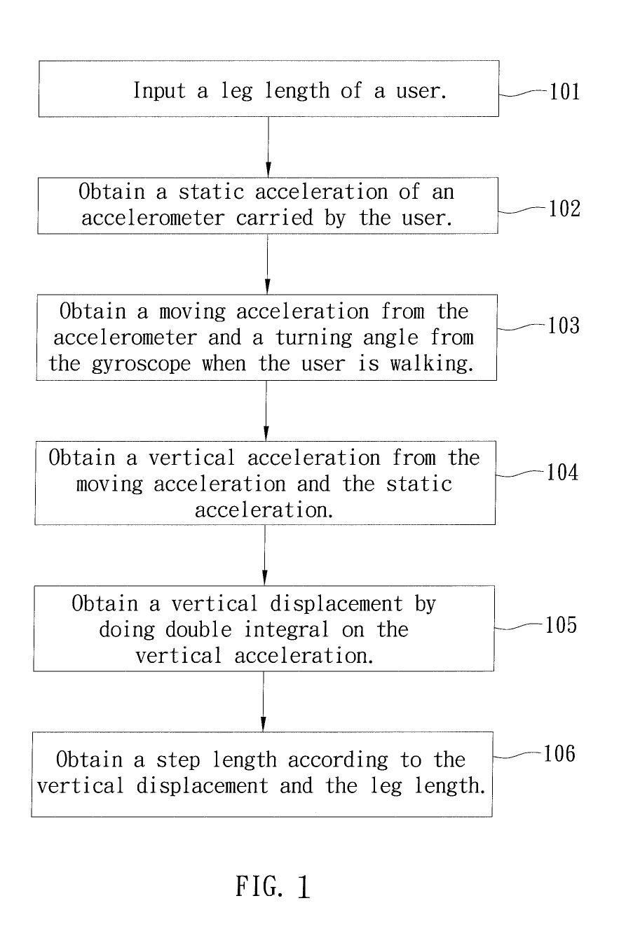

As shown in FIG. 1, the method includes the following steps:

Step 101, input a leg length into the computing device. In an embodiment, the leg length is a length between a hip joint and a sole of a foot of a user.

Step 102, obtain a static acceleration of the accelerometer. The static acceleration is the acceleration sensed by the accelerometer when the user, who carries the computing device, stands still. The static acceleration occurs because of gravity.

Step 103, obtain a moving acceleration from the accelerometer and a turning angle from the gyroscope when the user is walking.

Step 104, obtain a vertical acceleration from the moving acceleration and the static acceleration. The vertical acceleration is the pure acceleration of the computing device in a vertical movement without the influence of gravity. An equation to obtain the vertical acceleration is:

An=(R−M)×sec(cos⁻¹(M/9.8))

where An is the vertical acceleration, R is the sensed acceleration, and M is the static acceleration.

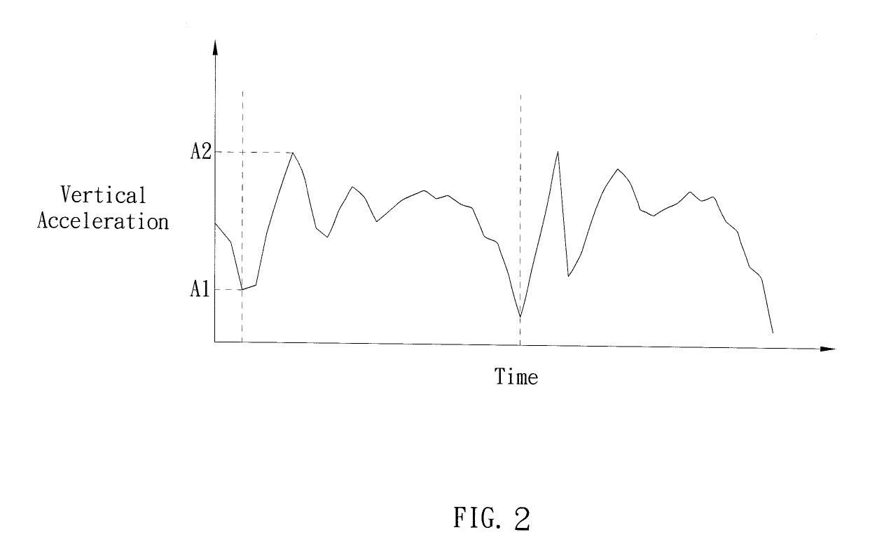

FIG. 2 shows a relation between the vertical acceleration and time. There are three major events in one step, including heel-off-ground, stance, and heel-touching ground. In FIG. 2, the first valley A1 of the wave indicates when the heel is touching the ground, the first peak A2 indicates the user in stance state, the second valley A3 indicates when the heel is just off the ground, and the third valley A4 indicates when the heel is touching the ground again. It is understood that one step occurs from A1 to A4.

During walking, the computing device is moved to the lowest position when the user steps forward and the heel touches the ground, and the computing device is moved to the highest position when one foot is on the ground and the other swinging forward. In other words, the computing device will be reciprocating between the highest position and the lowest position. The motion of the computing device is simulated as Simple Harmonic Motion (SHM).

According to the characteristic of SHM, when the computing device is moved to the lowest position or the highest position, the vertical velocity is zero and the vertical acceleration reaches its relative maximum.

There are often unexpected vibrations happening during walking, for example, the computing device may be hit by hand unintentionally, and that will affect the accuracy of calculation. The present invention further provides a low-pass filtering step to filter out low frequency waves to eliminate the noises of signals.

Step 105, obtain a vertical displacement by double integral on the vertical acceleration.

When a new step event is detected, the computing device can calculate the vertical displacement of the computing device by doing double integral on the vertical acceleration over time. However, in order to avoid the accumulated errors from the results of double integral, we need to do zero velocity update (ZUPT) to avoid the error accumulation. Given that the computing device worn on the user is moving in SHM, we can find the highest position (the maximum acceleration) A2 and the lowest position (the minimum acceleration) A1 in FIG. 2, and reset the velocities of these two positions to zero.

However, if we do the double integral on the vertical acceleration over the interval between A1 and A3, the result will be zero or close to zero because the computing device moves from the lowest position to the highest position, and back to the lowest position again. Therefore, except doing the integral on the vertical acceleration to obtain vertical velocity, we do another integral on the absolute value of the vertical velocity. The result of the second integral is then divided by two to obtain an average displacement, and the average displacement is taken as the vertical displacement of the computing device.

In the present invention, each step can be divided into two parts: from stance to stride and from stride back to stance. Therefore, the first step (start to walk) and the last step (stop walking) can only be considered as half a step. The result of the double integral of the vertical acceleration will not be divided by two for the case of the first or the last step. In addition, there is only one position where the velocity needs to be reset. The initial velocity of the first step is already zero, and the last step does not need to reset the velocity when the user is in the stance state.

Step 106, obtain a step length from the vertical displacement and the leg length by Pythagorean theorem.

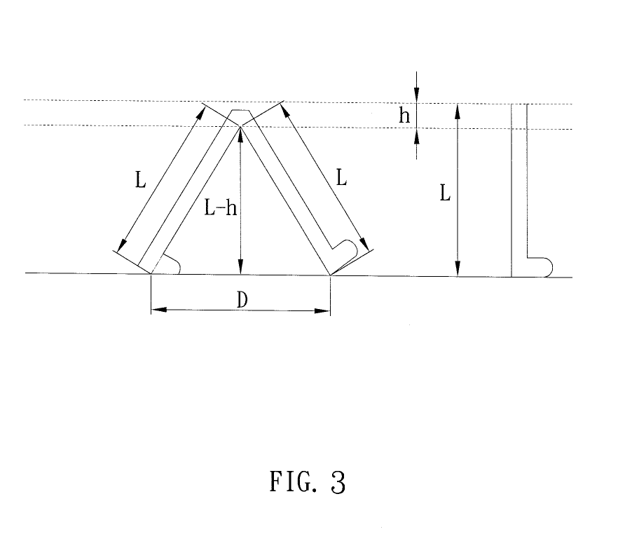

As shown in FIG. 3, if the leg length is L and the vertical displacement is h, L−h (L minuses h) is the distance between the user's hip joint and ground when the user steps forward, and the distance between two feet is the step length D.

The step length D may be obtained by the following equation:

D=2×\sqrt{L²−(L−h)²}

In the step 103, we also obtain the turning angle from the gyroscope. The gyroscope detects an angle of turning of the computing device when the user turns, which can be used to calculate the user's coordinate and trajectory in a 2D space.

Finally, we can combine the step length and the turning angle to calculate the user's coordinate and trajectory in a 2D space. The equation of calculating a X coordinate of the trajectory is

Xₙ=Xₙ₋₁+D×cosθ

where Xₙ is the current X coordinate; Xₙ₋₁ is the previous X coordinate; and θ is the turning angle, wherein Xₙ₋₁ is zero for the first step.

The equation of calculating a Y coordinate of the trajectory is

Yₙ=Yₙ₋₁+D×sinθ

where Yₙ is the current Y coordinate; Yₙ₋₁ is the previous Y coordinate; and θ is the turning angle, wherein Yₙ₋₁ is zero for the first step.

With the computing device of the present invention, it may accurately position the user without GPS system. Except for the pedestrian dead reckoning (PDR) device, the smart phone can be the computing device of the present invention if it is equipped with an accelerometer and a gyroscope, and stalled with a suitable application.

It must be pointed out that the embodiments described above are only some preferred embodiments of the present invention. All equivalent methods which employ the concepts disclosed in this specification and the appended claims should fall within the scope of the present invention.

What is claimed is:

1. A method of calculating a step length, comprising the steps of:
A. inputting a leg length of a user;
B. obtaining a vertical acceleration when the user is walking;
C. doing double integral on the vertical acceleration to obtain a vertical displacement for one step of the user; and
D. calculating a step length according to the vertical displacement and the leg length.

2. The method of claim 1, wherein the leg length is a distance between a hip joint and a sole of a foot of the user.

3. The method of claim 1, wherein the step B comprises the steps of obtaining a static acceleration by an accelerometer when the user is standing still; obtaining a moving acceleration by the accelerometer when the user is walking; and then removing the static acceleration from the moving acceleration to obtain the vertical acceleration.

4. The method of claim 3, wherein an equation of calculating the vertical acceleration is An=(R−M)×sec(cos⁻¹(M/9.8)), where An is the vertical acceleration, R is the moving acceleration, and M is the static acceleration.

5. The method of claim 1, further comprising the step of low-pass filtering after the step B, to filter out low frequency waves of the vertical acceleration generated by vibration.

6. The method of claim 1, wherein the step C comprises the steps of doing integral on the vertical acceleration to obtain a vertical velocity; and then doing another integral on an absolute value of the vertical velocity; and then a result of the second integral is divided by two to obtain the vertical displacement.

7. The method of claim 6, wherein the vertical acceleration is obtained via an accelerometer, and the vertical velocity is reset to zero when the accelerometer is at a highest position and a lowest position.

8. The method of claim 7, wherein a movement of the accelerometer is simulated as Simple Harmonic Motion (SHM).

9. The method of claim 1, wherein the step C comprises the steps of doing integral on the vertical acceleration to obtain a vertical velocity, and then doing another integral on an absolute value of the vertical velocity to obtain the vertical displacement for the step when the user starts to walk or stops walking.

10. The method of claim 9, wherein the vertical acceleration is obtained via an accelerometer, and the vertical velocity is reset to zero when the accelerometer is at a lowest position.

11. The method of claim 10, wherein a movement of the accelerometer is simulated as Simple Harmonic Motion (SHM).

12. The method of claim 1, wherein an equation of calculating the step length in the step D is D=2×\sqrt{L²−(L−h)²}, where D is the step length, L is the leg length, and h is the vertical displacement.

13. The method of claim 1, further comprising a turning angle by using a gyroscope to calculate a coordinate of the user in a 2D space, wherein the step length is combined with the turning angle to obtain a trajectory of the user in the 2D space.

14. The method of claim 13, wherein a X coordinate of the coordinate is obtained via an equation Xₙ=Xₙ₋₁+D×cosθ, and a Y coordinate of the coordinate is obtained via an equation Yₙ=Yₙ₋₁+D×sinθ, where Xₙ is the current X coordinate, Xₙ₋₁ is the previous X coordinate, Yₙ is the current Y coordinate, Yₙ₋₁ is the previous Y coordinate; and θ is the turning angle, wherein Xₙ₋₁ and Yₙ₋₁ are zero if this is the first step.
